(19) United States
(12) Patent Application Publication
(10) Pub. No.: US 2006/0250950 A1
(43) Pub. Date: Nov. 9, 2006

(54) Data acquisition apparatus and data acquisition method

(75) Inventor: Hiroaki Tanaka, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/393,517

(22) Filed: Mar. 29, 2006

(30) Foreign Application Priority Data
Mar. 30, 2005 (JP) 2005-097746

(51) Int. Cl. H04J 1/16

(52) U.S. Cl. 370/216

(57) ABSTRACT

A data acquisition apparatus acquires data through a network in which nodes are autonomously communicable with each other. The data acquisition apparatus has a storage section and an acquiring section. The storage section stores a table including a physical address indicating a storage location of data possessed by a monitored node connected to the network. The acquiring section refers the table stored in the storage section to acquire data stored in a location indicated by a predetermined physical address. The acquiring section also provides the acquired data to a monitoring node.

### CROSS-REFERENCE TO RELATED APPLICATIONS

This application is based upon and claims the benefit of priority from the prior Japanese Patent Applications No. 2005-097746, filed on Mar. 30, 2005, the entire contents of which are incorporated herein by reference.

### BACKGROUND OF THE INVENTION

1. Field of the Invention

The present invention relates to a data acquisition apparatus and data acquisition method that acquire data through a network in which devices connected to a common network are autonomously communicable with each other.

2. Description of the Related Art

As a network for distributed control, LonWorks (trademark) network is known. The network is applied to various fields such as building automation, and industrial automation. A neuron chip is incorporated in a node of the LonWorks device connected to the network, so that each node can autonomously communicate with another node without being routed through a gateway, a device which centrally processes communication, or the like. A data possessed by each node is called a network variable. A network variable can be transferred by communication between nodes.

A communication device related to the invention is disclosed in JP-A-2003-224570.

JP-A-2003-224570 is referred to as a related art of the communication device.

When LonWorks devices are used as a monitoring node and a monitored node to be monitored by the monitoring node, network variables possessed by the monitored nodes are sequentially acquired by the monitoring node, and data are updated, thereby monitoring in real time the monitored nodes. As a method of updating data, one of two methods, or a method of executing polling of the network variables possessed by the monitored nodes, and a method (asynchronous communication) of updating data in response to a notification from a monitored node by binding is used as a method according to the communication protocol (LonTalk). In both the methods, however, communication must be performed for each one of network variables. In a related method, when plural monitored nodes exist, or when values of plural network variables possessed by the same monitored node are to be acquired, communication of one request/reply, or reception of a data updating packet is required for each network variable.

Therefore, when there are many network variables to be monitored, a long time is required to acquire the network variables, and a sufficient monitoring function cannot be obtained.

### SUMMARY OF THE INVENTION

An object of the invention is to provide a data acquisition apparatus and data acquisition method in which data used in monitored nodes can be promptly obtained.

The invention provides a data acquisition apparatus for acquiring data through a network in which nodes are autonomously communicable with each other. The data acquisition apparatus has: a storage section which stores a table including a physical address indicating a storage location of data possessed by a monitored node connected to the network; and an acquiring section which refers the table stored in the storage section, and providing the acquired data to a monitoring node.

According to the data acquisition apparatus, the monitoring node acquires data at the predetermined physical address with reference to the table, and hence the time required for acquiring data can be shortened. A plurality of data may be collectively acquired, or alternatively each data may be individually acquired.

In the data acquisition apparatus, the network may be LonWorks network.

In the data acquisition apparatus, the acquiring section collectively acquires a plurality of data to provide the acquired data to the monitoring node.

In this case, the plurality of data is collectively acquired, and therefore the time required for acquiring data can be further shortened.

The data acquisition apparatus may further have a table producing section which acquires address information from the monitored node, to previously produce the table.

The invention also provides a data acquisition method of acquiring data through a network in which nodes are autonomously communicable with each other. The method includes the steps of: storing a table including a physical address indicating a storage location of data possessed by a monitored node connected to the network; referring the table to acquire data stored in a location indicated by a predetermined physical address; and providing the acquired data to a monitoring node.

According to the data acquisition method, data at the predetermined physical address are acquired with reference to the table, and hence the time required for acquiring data can be shortened. The plurality of data may be collectively acquired, or alternatively each data may be individually acquired.

In the data acquisition method, the network may be LonWorks network.

In the data acquisition method, in the step of acquiring data, a plurality of data is collectively acquired.

In this case, the plurality of data is collectively acquired, and therefore the time required for acquiring data can be further shortened.

The data acquisition method may further include a step of acquiring address information from the monitored node, to previously produce the table.

According to the data acquisition apparatus and the data acquisition method, data at the predetermined physical address are acquired with reference to the table, and hence the time required for acquiring data can be shortened.

### BRIEF DESCRIPTION OF THE DRAWINGS

FIG. 1 is a block diagram functionally showing the data acquisition apparatus of an embodiment of the invention;

FIG. 2 is a block diagram showing the configuration of a network to which a data acquisition apparatus of the embodiment is applied;

FIGS. 3A and 3B are flowcharts showing an operation procedure of a monitoring node;

FIG. 4 is a view showing a table and network variable memory map which are stored in a monitored node; and

FIG. 5 is a view showing the configuration of the network variable (NV) memory map.

### DETAILED DESCRIPTION OF THE PREFERRED EMBODIMENTS

FIG. 1 is a block diagram functionally showing the data acquisition apparatus of an embodiment of the invention.

Referring to FIG. 1, a storage section 101 stores a table 103 including physical addresses indicating storage location of data possessed by a monitored node which is connected to a network. An acquiring section 102 refers the table 103 stored in the storage section 101 to acquire data stored in a location indicated by a predetermined physical address, and provides the acquired data to a monitoring node. A table producing section 105 acquires address information from the monitored node, to previously produce the table to be stored into the storage section 101.

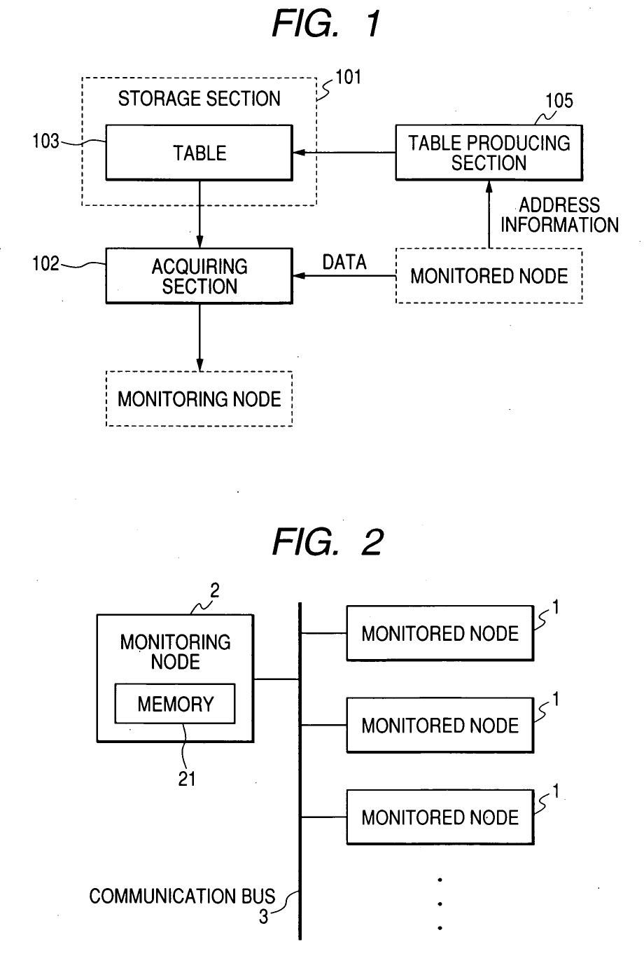

Hereinafter, an embodiment of the data acquisition apparatus of the invention will be described with reference to FIGS. 2 to 5.

FIG. 2 is a block diagram showing the configuration of a network to which the data acquisition apparatus of the embodiment is applied.

As shown in FIG. 2, the network has: a plurality of monitored nodes 1, 1, . . . ; a monitoring node 2 which monitors network variables of the monitored nodes 1, 1, . . . ; and a communication bus 3 through which the monitored nodes 1, 1, . . . and the monitoring node 2 are connected to one another. A memory 21 which stores a network variable memory map is disposed in the monitoring node 2.

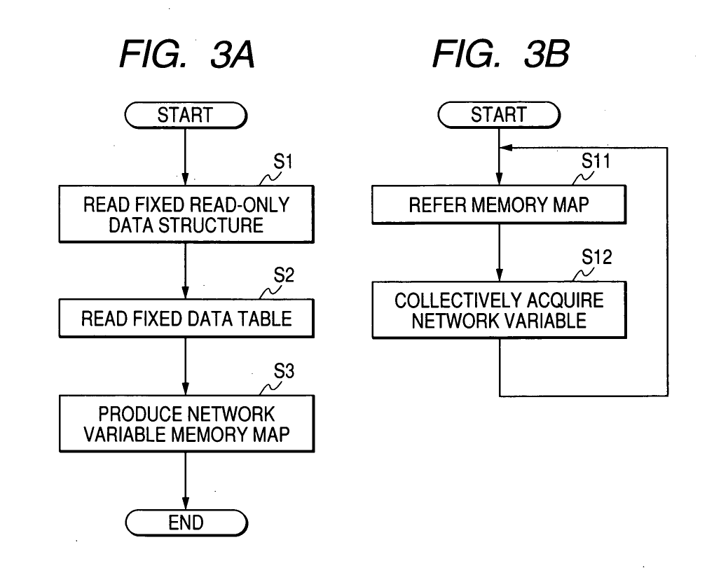

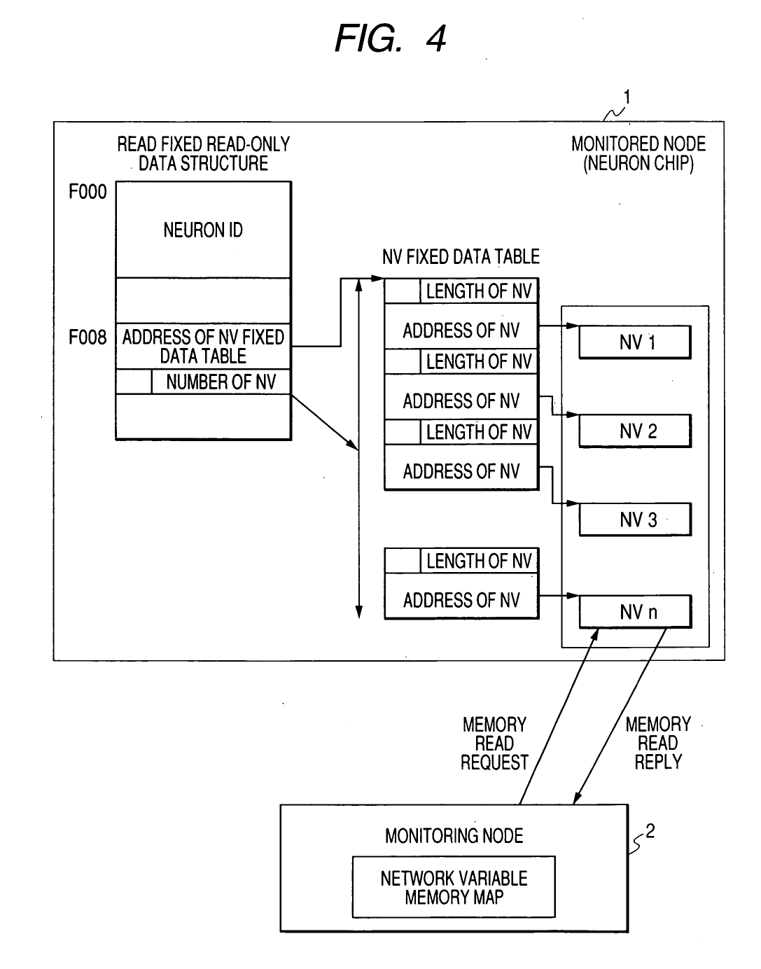

FIGS. 3A and 3B are flowcharts showing an operation procedure of the monitoring node 2, and FIG. 4 is a view showing a table stored in one of the monitored nodes, and the like.

Steps S1 to S3 of FIG. 3A show a procedure of producing and storing the variable memory map in the monitoring node 2.

In step S1 of FIG. 3A, a fixed read-only structure stored in the monitored node 1 is read. As shown in FIG. 4, the address of a network variable (NV) fixed data table which stores network variables (NV), and the number of the network variables are defined in the fixed read-only structure. The monitoring node 2 acquires the information.

Next, in step S2, a network fixed data table is read in accordance with the address obtained from the fixed read-only structure. As shown in FIG. 4, physical addresses at which the values of the network variables are stored, and the lengths of the network variables are defined in the network fixed data table. The monitoring node 2 acquires the address information.

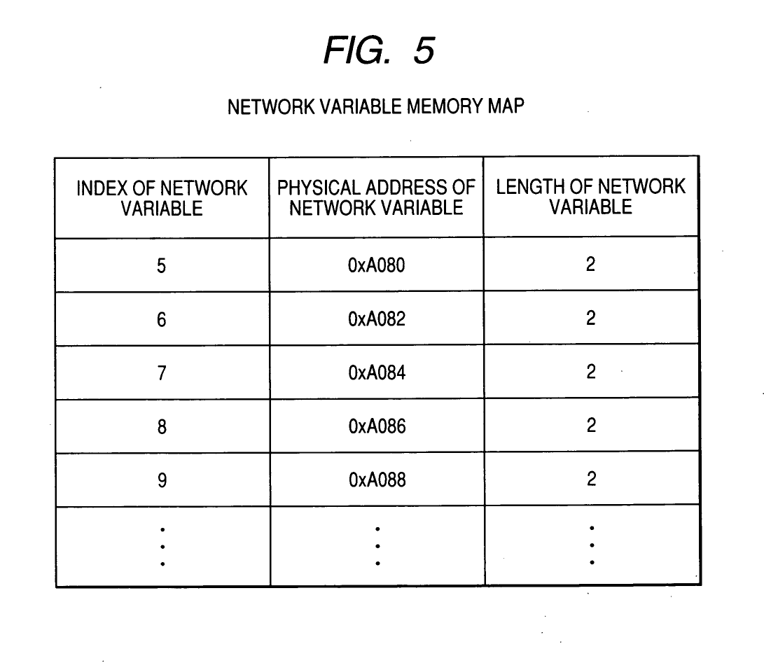

Next, in step S3, a network variable (NV) memory map shown in FIG. 5 is produced, and the map is stored in the memory 21 (FIG. 2) of the monitoring node 2. As shown in FIG. 5, the network variable memory map is a table which associates storage destination physical addresses of network variables obtained from the network fixed data table, and the lengths of the network variables with indexes of the network variables. In this way, the network variable (NV) memory map is produced on the basis of the address information.

As described above, the monitoring node 2 produces the network variable memory map in the procedure shown in steps S1 to S3, and stores the map into the memory 21. For example, the procedure may be collectively executed with respect to all the monitored nodes 1 at startup of the system, and the network variable memory map may be produced and stored for all of the monitored nodes 1.

Steps S11 and S12 of FIG. 3B show a procedure of updating data with using the network variable memory map.

In step S11 of FIG. 3B, the network variable memory map stored in the memory 21 is referred, and the storage destination physical address and length of a required network variable are acquired.

Next, in step S12, the physical address which is obtained from the network variable memory map is accessed with using a ReadMemory message, whereby the value of the corresponding network variable is acquired. The data of the monitoring node 2 are updated in accordance with the value.

Plural network variables can be collectively read by a ReadMemory message. The size which can be collectively read by a ReadMemory message depends on the buffer lengths of the monitoring node 2 and the monitored node 1 (when a router is included in the path, also the buffer length of the router is considered). A node which is compliant to the Lonmark interoperability standard can read 16-byte data. Therefore, plural network variables with a 1-, 2-, or 4-byte length which are often used in applications can be collectively read. Alternatively, each of network variables may be independently read from the corresponding physical address with reference to the network variable memory map.

When steps S11 and S12 of FIG. 3B are repeatedly executed, network variables are sequentially acquired, and data of the monitoring node 2 are updated. During the period when steps S11 and S12 are repeated, the network variable memory map which is previously produced and stored can be used. Therefore, it is not required to repeat the procedure of producing and storing the network variable memory map (steps S1 to S3).

As described above, in the embodiment, plural network variables can be collectively read with using the network variable memory map, and the time required for acquiring network variables and updating data can be greatly shortened.

The above-described method in which network variables are collectively acquired, and a method by binding, i.e., a method in which a network variable is read in response to a notification from the monitored node 1 may be combinedly used. The procedure of producing the network variable memory map may be implemented in a LonWorks network management tool, and a result of the production may be downloaded to the monitoring node 2.

As described above, according to the embodiment, fast collection of network variables is enabled under the LonTalk protocol system while securing the interoperability.

The scope of the invention is not restricted to the embodiment. The invention can be widely applied in the case where data acquisition is executed through a network in which nodes are autonomously communicable with each other.

What is claimed is:

1. A data acquisition apparatus for acquiring data through a network in which nodes are autonomously communicable with each other, comprising:
a storage section which stores a table including a physical address indicating a storage location of data possessed by a monitored node connected to the network; and
an acquiring section which refers the table stored in the storage section to acquire data stored in a location indicated by a predetermined physical address, and provides the acquired data to a monitoring node.

2. The data acquisition apparatus according to claim 1,
wherein the network is LonWorks network.

3. The data acquisition apparatus according to claim 1,
wherein the acquiring section collectively acquires a plurality of data to provide the acquired data to the monitoring node.

4. The data acquisition apparatus according to claim 1, further comprising:
a table producing section which acquires address information from the monitored node, to previously produce the table.

5. A data acquisition method of acquiring data through a network in which nodes are autonomously communicable with each other, comprising the steps of:
storing a table including a physical address indicating a storage location of data possessed by a monitored node connected to the network;
referring the table to acquire data stored in a location indicated by a predetermined physical address; and
providing the acquired data to a monitoring node.

6. The data acquisition method according to claim 5,
wherein the network is LonWorks network.

7. The data acquisition method according to claim 5,
wherein, in the step of acquiring data, a plurality of data are collectively acquired.

8. The data acquisition method according to claim 5, further comprising the step of:
acquiring address information from the monitored node, to previously produce the table.
